(19) United States
(12) Patent Application Publication
(10) Pub. No.: US 2017/0206228 A1
(43) Pub. Date: Jul. 20, 2017

(54) GRADATED RESPONSE INDICATIONS AND RELATED SYSTEMS AND METHODS

(71) Applicant: BBMLF Investment Holdings LTD, Road Town (VG)

(72) Inventors: Rick Clay, Spicewood, TX (US); Bogdan Dobran, Cascais (PT); Deniss Klimovs, Caxias (PT)

(21) Appl. No.: 15/001,102

(22) Filed: Jan. 19, 2016

(51) Int. Cl. G06F 17/30; G06F 3/0482

(52) U.S. Cl. CPC G06F 17/30274; G06F 3/0482; G06F 17/30073

(57) ABSTRACT

Various computer systems may benefit from appropriate mechanism for indicating or communicating user response. For example, gradated response indications may permit users to communicate in a finely tuned way. A method can include soliciting, from a user, a set of indicators. The method can also include archiving the set of indicators. The method can further include providing the set of indicators as options for selection by the user responsive to a displayed item.

### BACKGROUND

Field

Various computer systems may benefit from appropriate mechanism for indicating or communicating user response. For example, gradated response indications may permit users to communicate in a finely tuned way.

Description of the Related Art

Computer systems today provide a variety of indicators of user response. Available indicators include binary indicators, such as “like,” “thumbs up,” and “+1” buttons, as well as more complex indicators, such as comment boxes.

### SUMMARY

According to certain embodiments, a method can include soliciting, from a user, a set of indicators. The method can also include archiving the set of indicators. The method can further include providing the set of indicators as options for selection by the user responsive to a displayed item.

In certain embodiments, an apparatus can include at least one processor and at least one memory including computer program code. The at least one memory and the computer program code can be configured to, with the at least one processor, cause the apparatus at least to solicit, from a user, a set of indicators. The at least one memory and the computer program code can also be configured to, with the at least one processor, cause the apparatus at least to archive the set of indicators. The at least one memory and the computer program code can further be configured to, with the at least one processor, cause the apparatus at least to provide the set of indicators as options for selection by the user responsive to a displayed item.

A non-transitory computer-readable medium, according to certain embodiments, can be encoded with instructions that, when executed in hardware, perform a process. The process can include soliciting, from a user, a set of indicators. The process can also include archiving the set of indicators. The process can further include providing the set of indicators as options for selection by the user responsive to a displayed item.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

FIG. 3 illustrates another method according to certain embodiments.

### DETAILED DESCRIPTION

Certain embodiments may provide gradated response indications, as well as related systems and methods. These gradated response indications may include, for example, a range of facial expressions. The facial expressions may include smiles, neutral expressions, or frowns. Other facial expressions, such as silly, angry, or other emotive faces are also permitted. While smiles are used as an example herein, it should be understood that other expressions are also permitted.

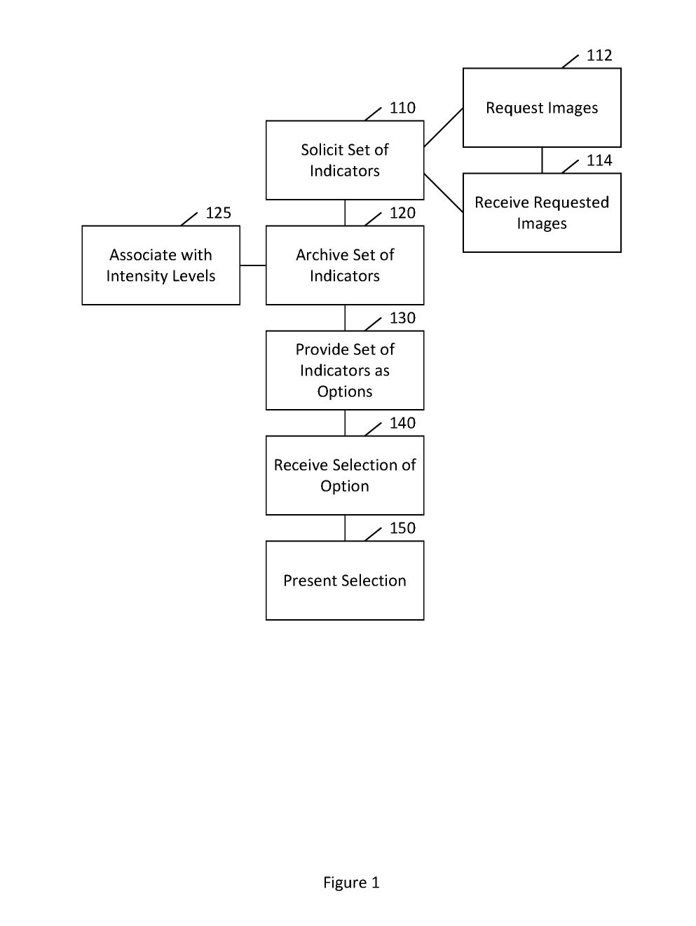

FIG. 1 illustrates a method according to certain embodiments. The method of FIG. 1 may be performed by a computer system. The method can include, at 110, soliciting, from a user, a set of indicators. The user can be solicited through a graphical user interface (GUI) or any similar mechanism for obtaining user response. For example, the user can be presented with a form that solicits the set of indicators.

The soliciting can include, at 112, requesting a plurality of images of the face of the user. The soliciting can also include, at 114, receiving the requested images. The images can be requested to be uploaded by a user. Alternatively, or in addition, the system can control a camera of the user to take images of the user's face. The system may permit the user to crop or otherwise images before or after uploading the images.

In certain embodiments, the images may be cropped so that only a region around the user's mouth is visible, less than the whole face of the user. For example, the user's chin mouth, and nose may be visible, while the user's eyes and forehead may be excluded. Other cropping arrangements are permitted.

While certain embodiments may involve the user uploading static images, in other embodiments the user may be permitted to upload a video image with or without sound. In certain embodiments, a short animated image file, such an animated GIF, can be uploaded or produced based on a received video file.

The requested image may be subject to a variety of manipulations. For example, there may be an option to increase symmetry of the image by creating a left side as a mirror image of the right side, or vice versa. Image manipulation tools may also be used to increase the size of a smile in the image, including increasing the size of the mouth relative to other parts of the face, or increasing the width or height of the smile.

In certain embodiments, a user may upload one image of a smile and the computer system can automatically produce a variety of manipulated smiles based on the uploaded image. The computer system may do this through individually enhancing or the image, or by comparing the image to other smiles in a database and interpolating an image of a related smile, such as a bigger or smaller smile, based on similarities between the current smile and the reference smile and changes present in the modified smiles for the reference smile. Alternatively, the system may generate intermediate smiles from two or more different levels of smile that were provided by a user.

Optionally further images can be associated with the stored image. For example, a full face image can be stored together with the smile. Alternatively, a picture of a full face can be stored, together with metadata defining the smile area of the face.

The method can also include, at 120, archiving the set of indicators. The archiving can include storing the indicators in a database. The database can be local to a user's own computer system, it can be at an application server, or it can be remote from both an application server and the user's computer system.

The archiving can also include more than just storage. The archiving can include, at 125, associating each of the indicators with one of a plurality of gradated levels of expression, such as enthusiasm of the user. The levels of expression may be of a relatively small number, such as five levels, or an entire set of emoticons can be mapped. In the five-level system, the levels may be neutral, some happiness, some unhappiness, strong happiness, and strong unhappiness. The computer system may tag the image with metadata representative of one or more of the levels of expression.

When soliciting the set of images, the computer system may request the user to identify the level to which the image should be associated. For example, the computer system may display five empty rectangles labeled accordingly and the user may be prompted to drag and drop an appropriate image into each empty box. In another case, the user may be asked to select a level using a radio button. In other cases, the user may be asked to individually tag the level.

The levels may be preset levels or user-generated levels. For example, the user may be queried for a label in a free text form and then the label may serve as a selectable level for later use. Alternatively, the system may have levels that are preconfigured, or which can only be set by an administrator.

In certain embodiments, the system may store only a single image per user for a particular level of expression or label. Thus, for example, if the user uploads a new “neutral” image, this can replace any previous neutral image for that user in the database. Alternatively, the system can maintain old images but further indicate, for a particular label, a currently selected image. Other archiving techniques are also permitted.

The method can further include, at 130, providing the set of indicators as options for selection by the user responsive to a displayed item. This providing of the options can be done in a completely different session from the preceding steps.

The displayed item can be an image, video, article, blog post, social media status, message, review, or the like. Certain embodiments can be applied in a variety of different contexts, such as any context in which a “like” button or a request for rating can be provided.

The providing the set of indicators can include displaying the set of indicators on a user interface for selection by the user. For example, the previously uploaded images can be displayed to the user for the user to select from their own images. Alternatively, or in addition, the set of indicators can be provided by displaying a verbal, numerical, or other indication of the available intensities for selection by the user. For example, the user may be prompted to select a label that best describes the user's reaction to a video, social media post, or the like. In certain embodiments, the user may be prompted using a set of generic emoticons, rather than the specific images the user previously uploaded.

The method can additionally include, at 140, receiving a selection from the provided set of indicators. For example, the user may click on a desired image, and the system may detect this click. Any desired user input mechanism can be employed to communicate the selection to the computer system.

The method can also include, at 150, presenting the selection in association with the displayed item. This presentation can be made to the user or to the public or to any predefined group, such as people connected to the user on social media. The image can be provided with a hyper-link to the user's profile, webpage, or the like. The image can be configured such that when a mouse pointer hovers over the image, the image expands to the full face of the user. This can be accomplished using metadata to display only a portion of the image at first, or by having a second image of the full face associated with the smile image.

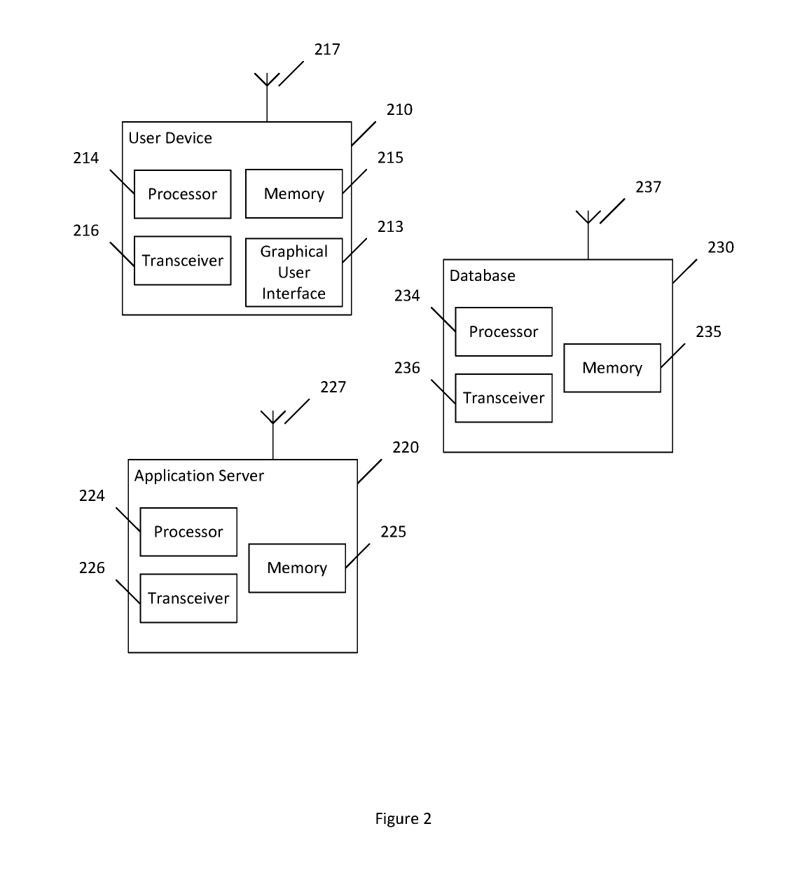

FIG. 2 illustrates a system according to certain embodiments of the invention. In one embodiment, a system may include multiple devices, such as, for example, at least one user device 210, at least one application server 220, and at least one database 230.

Each of these devices may include at least one processor, respectively indicated as 214, 224, and 234. At least one memory can be provided in each device, and indicated as 215, 225, and 235, respectively. The memory may include computer program instructions or computer code contained therein. The processors 214, 224, and 234 and memories 215, 225, and 235, or a subset thereof, can be configured to provide means corresponding to the various blocks of FIG. 1.

As shown in FIG. 2, transceivers 216, 226, and 236 can be provided, and each device may also include an antenna, respectively illustrated as 217, 227, and 237. Other configurations of these devices, for example, may be provided. For example, database 230 may be configured for wired communication, in addition to or instead of wireless communication, and in such a case antenna 237 can illustrate any form of communication hardware, without requiring a conventional antenna.

Transceivers 216, 226, and 236 can each, independently, be a transmitter, a receiver, or both a transmitter and a receiver, or a unit or device that is configured both for transmission and reception.

Processors 214, 224, and 234 can be embodied by any computational or data processing device, such as a central processing unit (CPU), application specific integrated circuit (ASIC), or comparable device. The processors can be implemented as a single controller, or a plurality of controllers or processors.

As shown in FIG. 2, user device 210 can include a graphical user interface 213. The graphical user interface 213 may include a video card and associated drivers and memory, as well as a monitor, such as a touch screen. Additional peripherals for use of user device 210 can also be included.

Memories 215, 225, and 235 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as user device 210, application server 220, and database 230, to perform any of the processes described herein (see, for example, FIG. 1). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 2 illustrates a system including a user device, application server, and database, embodiments of the invention may be applicable to other configurations, and configurations involving additional elements. For example, not shown, additional user devices may be present, and additional core network elements may be present, as illustrated in FIG. 2.

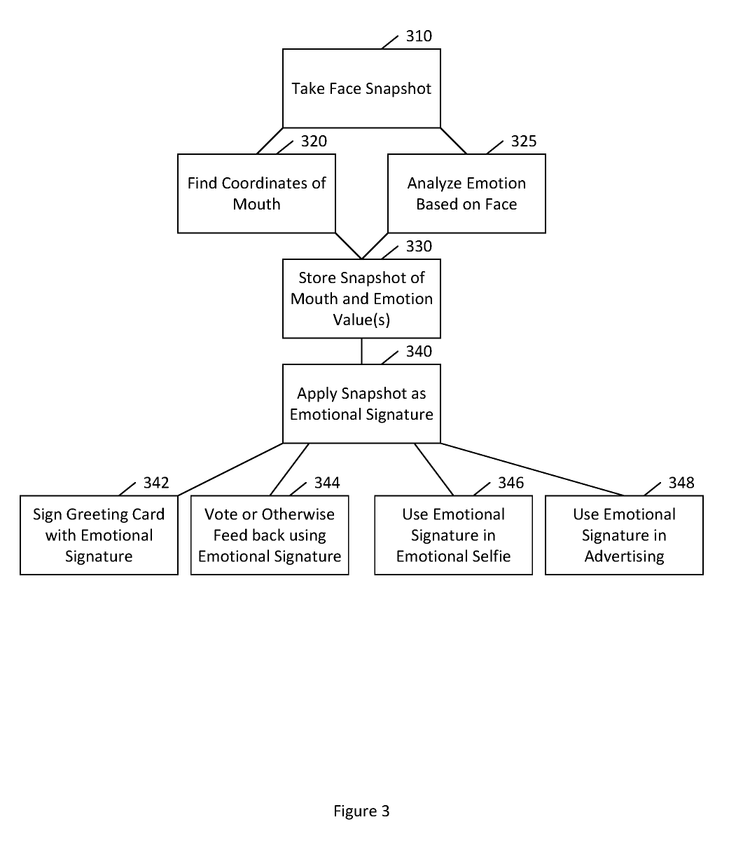

FIG. 3 illustrates another method according to certain embodiments. More particularly, as shown in FIG. 3 certain embodiments may represent a snapshot of a person's emotion through a snapshot of a smile. The way this can work is by, at 310, taking a face snapshot, through any mechanism such as phone, uploading, a website, or the like. Next, at 320, the system can process the face snapshot in order to find coordinates of the mouth. The system can also, at 325, analyze emotions based on the entire face. The system can then, at 330, store the snapshot of the mouth with some margins, together with the values of the emotions. The storing of the snapshot of the mouth with some margins can be done first, and the values of the emotions can be subsequently updated to the stored snapshot of the mouth, in certain embodiments.

This mouth snapshot can serve as a snapshot of a real person's actual emotion. Thus, this stored snapshot can be used as an emotional signature. While the mouth may not be a unique face feature that would allow a person to be identified by it, the mouth may represent enough of the person in order to create the feeling of an emotional signature. Thus, the mouth snapshot may provide a way to virtualize a real emotion, which can be associated within some limits with a known person. For example, if you know the person, you may be able to recognize their smile or other expression from the snapshot.

The system can further, at 340, apply the snapshot as an emotional signature. There can be many examples of using such a technique. For example, greeting cards can be signed with such emotional signature at 342. For a person that knows the sender, such an emotion can both identify the person and contain a snapshot of the emotion sent, be it a smile, a grin, a frown.

Alternatively, the emotional signature can be used as a method of voting at 344, or other similar real feedback, or even instead of a comment, as an emotion can be seen as a comment. Because it may require more effort than just clicking on a link, and can store the emotion the user chose to show at that point, such a comment may have a stronger value than a conventional vote. Moreover, since the snapshot may partially identify a human behind it, the snapshot may be more easily associated with a real person as opposed to a pure virtual screenname

Another alternative, may involve, at 346, using the emotional signature as an emotional selfie, overlaying such an emotional snapshot over images being taking with a user's camera. In this way, the user's emotion and person can be connected with the image without necessarily actually being the object of the camera.

Because certain embodiments can attach emotional data to other data, there can also be other commercial applications where this can be used, such as in advertising at 348. The emotional data can represent the chances and intensities of various important emotions, such as joy, sadness, surprise, anger, disgust, scare, or the like. This data can be used both for presenting people's feedback in a more interesting way, such as a background formed from people's emotional snapshots, and also for using the above mentioned data for marketing study.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
soliciting, from a user, a set of indicators;
archiving the set of indicators; and
providing the set of indicators as options for selection by the user responsive to a displayed item.

2. The method of claim 1, the method further comprising:
receiving a selection from the provided set of indicators; and
presenting the selection in association with the displayed item.

3. The method of claim 1, wherein the soliciting comprises:
requesting a plurality of images of the face of the user; and
receiving the requested images.

4. The method of claim 1, wherein the archiving comprises:
associating each of the indicators with one of a plurality of gradated levels of enthusiasm of the user.

5. The method of claim 1, wherein the archiving includes storing the indicators in a database.

6. The method of claim 1, wherein the providing comprises displaying the set of indicators on a user interface for selection by the user.

7. The method of claim 1, wherein the providing comprises displaying a set of intensities for selection by the user.

8. An apparatus, comprising:
at least one processor; and
at least one memory including computer program code;
wherein the at least one memory and the computer program code are configured to, with the at least one processor, cause the apparatus at least to
solicit, from a user, a set of indicators;
archive the set of indicators; and
provide the set of indicators as options for selection by the user responsive to a displayed item.

9. The apparatus of claim 8, wherein the at least one memory and the computer program code are configured to, with the at least one processor, cause the apparatus at least to
receive a selection from the provided set of indicators; and
present the selection in association with the displayed item.

10. The apparatus of claim 8, wherein the at least one memory and the computer program code are configured to, with the at least one processor, cause the apparatus at least to
request a plurality of images of the face of the user; and
receive the requested images.

11. The apparatus of claim 8, wherein the at least one memory and the computer program code are configured to, with the at least one processor, cause the apparatus at least to associate each of the indicators with one of a plurality of gradated levels of enthusiasm of the user.

12. The apparatus of claim 8, wherein the at least one memory and the computer program code are configured to, with the at least one processor, cause the apparatus at least to store the indicators in a database.

13. The apparatus of claim 8, wherein the at least one memory and the computer program code are configured to, with the at least one processor, cause the apparatus at least to display the set of indicators on a user interface for selection by the user.

14. The apparatus of claim 8, wherein the at least one memory and the computer program code are configured to, with the at least one processor, cause the apparatus at least to display a set of intensities for selection by the user.

15. A non-transitory computer-readable medium encoded with instructions that, when executed in hardware, perform a process, the process comprising:
soliciting, from a user, a set of indicators;
archiving the set of indicators; and
providing the set of indicators as options for selection by the user responsive to a displayed item.

16. The non-transitory computer-readable medium of claim 15, the process further comprising:
receiving a selection from the provided set of indicators; and
presenting the selection in association with the displayed item.

17. The non-transitory computer-readable medium of claim 15, wherein the soliciting comprises:
requesting a plurality of images of the face of the user; and
receiving the requested images.

18. The non-transitory computer-readable medium of claim 15, wherein the archiving comprises:
associating each of the indicators with one of a plurality of gradated levels of enthusiasm of the user.

19. The non-transitory computer-readable medium of claim 15, wherein the providing comprises displaying the set of indicators on a user interface for selection by the user.

20. The non-transitory computer-readable medium of claim 15, wherein the providing comprises displaying a set of intensities for selection by the user.
